(19) United States
(12) Patent Application Publication
(10) Pub. No.: US 2010/0121533 A1
(43) Pub. Date: May 13, 2010

(54) Seatbelt control apparatus

(75) Inventors: Masato Takao, Tokyo (JP); Daisuke Murakami, Tokyo (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 12/588,234

(22) Filed: Oct. 8, 2009

(30) Foreign Application Priority Data
Nov. 7, 2008 (JP) 2008-287208

(51) Int. Cl. B60R 22/48; B60R 22/08

(52) U.S. Cl. 701/45; 280/803

(57) ABSTRACT

A seatbelt apparatus including a seatbelt, a spool for retracting the seatbelt, a motor for rotatably driving the spool, and urging mechanism for urging the seatbelt toward a retracting direction. The seat belt apparatus further includes belt attaching/detaching mechanism, a belt releasing detecting mechanism and, and a motor controller. The belt attaching/detaching mechanism fastens or releases the seatbelt. The belt releasing detecting mechanism detects that the seatbelt is released from the belt attaching/detaching mechanism. The motor controller causes the motor to start to take up the seatbelt on the condition that a predetermined amount of time passes since the belt releasing detecting mechanism detects that the seatbelt is released.

### BACKGROUND

The present application relates to a seatbelt apparatus for restraining an occupant of a vehicle, a seatbelt control apparatus for controlling the retraction of a seatbelt, a seatbelt control method.

A vehicle such as a motor vehicle is generally provided with a seatbelt apparatus consisting of a seatbelt and the like for restraining an occupant such as a driver. As such a seatbelt apparatus, a seatbelt apparatus having, for example, a seatbelt retractor is known (see e.g., Japanese Unexamined Patent Application Publication No. 2005-231594, incorporated by reference herein). Such a seatbelt retractor consists of, for example, an electric motor for retracting a seatbelt, a seatbelt control apparatus for controlling the motor, and a return spring for urging a belt retraction shaft (a torsion bar) connected to the rotating shaft of the motor via a clutch or the like toward the retraction direction. However, such a seatbelt apparatus may experience abnormal noise emission from the clutch, depending on the timing on when the motor starts to drive.

### SUMMARY

One disclosed embodiment relates to a seatbelt apparatus including a seatbelt, a spool for retracting the seatbelt, a motor for rotatably driving the spool, and urging mechanism for urging the seatbelt toward a retracting direction. The seat belt apparatus further includes belt attaching/detaching mechanism, a belt releasing detecting mechanism and, a motor control mechanism or motor controller. The belt attaching/detaching mechanism fastens or releases the seatbelt. The belt releasing detecting mechanism detects that the seatbelt is released from the belt attaching/detaching mechanism. The motor controller causes the motor to start to take up the seatbelt on the condition that a predetermined amount of time passes since the belt releasing detecting mechanism detects that the seatbelt is released.

Another disclosed embodiment relates to a seatbelt control apparatus that controls an apparatus including a seatbelt, a spool for retracting the seatbelt, a motor for rotatably driving the spool, urging mechanism for urging the seatbelt toward a retracting direction; and belt attaching/detaching mechanism adapted to attach/detach the seatbelt for fastening or releasing the seatbelt. The seatbelt control apparatus comprises belt releasing detecting mechanism, and motor control mechanism or motor controller. The belt releasing detecting mechanism detects that the seatbelt is released from the belt attaching/detaching mechanism. The motor control mechanism or motor controller causes the motor to start to take up the seatbelt on the condition that a predetermined amount of time passes since the belt releasing detecting mechanism detects that the seatbelt is released.

Still another disclosed embodiment relates to a seatbelt control method for controlling an apparatus which includes a seatbelt, a spool for retracting the seatbelt, a motor for rotatably driving the spool, urging mechanism for urging the seatbelt toward a retracting direction, and belt attaching/detaching mechanism adapted to attach/detach the seatbelt for fastening or releasing the seatbelt. The seatbelt control method comprises a first step, a second step, and a third step. The first step involves determining an amount of time during which an urging force of the urging mechanism becomes weaker than a predetermined level. The second step involves detecting that the seatbelt is released from the belt attaching/detaching mechanism. The third step involves causing the motor to start to take up the seatbelt on the condition that the amount of time determined in the first step passes since the second step detects that the seatbelt is released.

Yet another disclosed embodiment relates to a program or method for controlling an apparatus which includes a seatbelt, a spool for retracting the seatbelt, a motor for rotatably driving the spool, urging mechanism for urging the seatbelt toward a retracting direction, and belt attaching/detaching mechanism adapted to attach/detach the seatbelt for fastening or releasing the seatbelt. The method enables a computer to carry out processing comprising a belt releasing detecting step, and a motor control step. The belt releasing detecting step involves detecting that the seatbelt is released from the belt attaching/detaching mechanism. The motor control step involves causing the motor to start to take up the seatbelt on the condition that a predetermined amount of time passes since the belt releasing detecting step detects that the seatbelt is released.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a block diagram showing an example of a configuration and connection of a seatbelt retractor with regard to the seatbelt apparatus, the seatbelt control apparatus, and the seatbelt control method according to an embodiment.

FIG. 2 is a perspective view showing the configuration of the motor retractor.

FIG. 3 is a perspective view showing the configuration of a seatbelt apparatus.

FIG. 4 is a flowchart illustrating belt retraction control.

FIG. 5 is a graph showing an example of the operation of a seatbelt apparatus.

FIG. 6 is a flowchart illustrating belt retraction control with regard to the seatbelt apparatus, the seatbelt control apparatus, and the seatbelt control method according to another exemplary embodiment.

FIG. 7 is a graph showing an example of the operation of a seatbelt apparatus.

### DETAILED DESCRIPTION

According to a first aspect, a seatbelt apparatus includes a seatbelt, a spool for retracting the seatbelt, and a motor for rotatably driving the spool. The seat belt apparatus further includes urging mechanism, belt attaching/detaching mechanism, belt releasing detecting mechanism, and motor control mechanism or motor controller. The urging mechanism biases the seatbelt toward a retraction direction. The belt attaching/detaching mechanism fastens or releases the seatbelt. The belt releasing detecting mechanism detects that the seatbelt is released from the belt attaching/detaching mechanism. The motor controller causes the motor to start to take up the seatbelt on the condition that a predetermined amount of time passes since the belt releasing detecting mechanism detects that the seatbelt is released. In the seatbelt apparatus, the motor controller may be configured to cause the motor to start to take up the seatbelt on the condition that the retracted amount of the seatbelt is equal to or greater than a predetermined level, in addition to the condition described above.

According to the second aspect, a seatbelt control apparatus controls a seatbelt apparatus including a seatbelt, a spool for retracting the seatbelt, and a motor for rotatably driving the spool. The seat belt apparatus further includes urging mechanism, belt attaching/detaching mechanism, belt releasing detecting mechanism, and motor control mechanism or motor controller. The urging mechanism biases the seatbelt toward a retraction direction. The belt attaching/detaching mechanism fastens or releases the seatbelt. The belt releasing detecting mechanism detects that the seatbelt is released from the belt attaching/detaching mechanism. The motor controller causes the motor to start to take up the seatbelt on the condition that a predetermined amount of time passes since the belt releasing detecting mechanism detects that the seatbelt is released.

According to the third aspect, a seatbelt control method controls an apparatus including a seatbelt, a spool for retracting the seatbelt, and a motor for rotatably driving the spool. The seat belt apparatus further includes urging mechanism, belt attaching/detaching mechanism, belt releasing detecting mechanism, and a motor control mechanism or motor controller. The urging mechanism biases the seatbelt toward a retraction direction. The belt attaching/detaching mechanism fastens or releases the seatbelt. The belt releasing detecting mechanism detects that the seatbelt is released from the belt attaching/detaching mechanism. The motor controller causes the motor to start to take up the seatbelt on the condition that a predetermined amount of time passes since the belt releasing detecting mechanism detects that the seatbelt is released.

According to the fourth aspect, a method controls an apparatus including a seatbelt, a spool for retracting the seatbelt, and a motor for rotatably driving the spool. The seat belt apparatus further includes urging mechanism, belt attaching/detaching mechanism, belt releasing detecting mechanism, and motor control mechanism or motor controller. The urging mechanism biases the seatbelt toward a retraction direction. The belt attaching/detaching mechanism fastens or releases the seatbelt. The belt releasing detecting mechanism detects that the seatbelt is released from the belt attaching/detaching mechanism. The motor controller causes the motor to start to take up the seatbelt on the condition that a predetermined amount of time passes since the belt releasing detecting mechanism detects that the seatbelt is released.

The present application discloses a seatbelt apparatus, a seatbelt control apparatus, and a seatbelt control method which can suppress abnormal noise emitted during the retraction of a belt. Also, the disclosed apparatus and methods can drive a motor more efficiently.

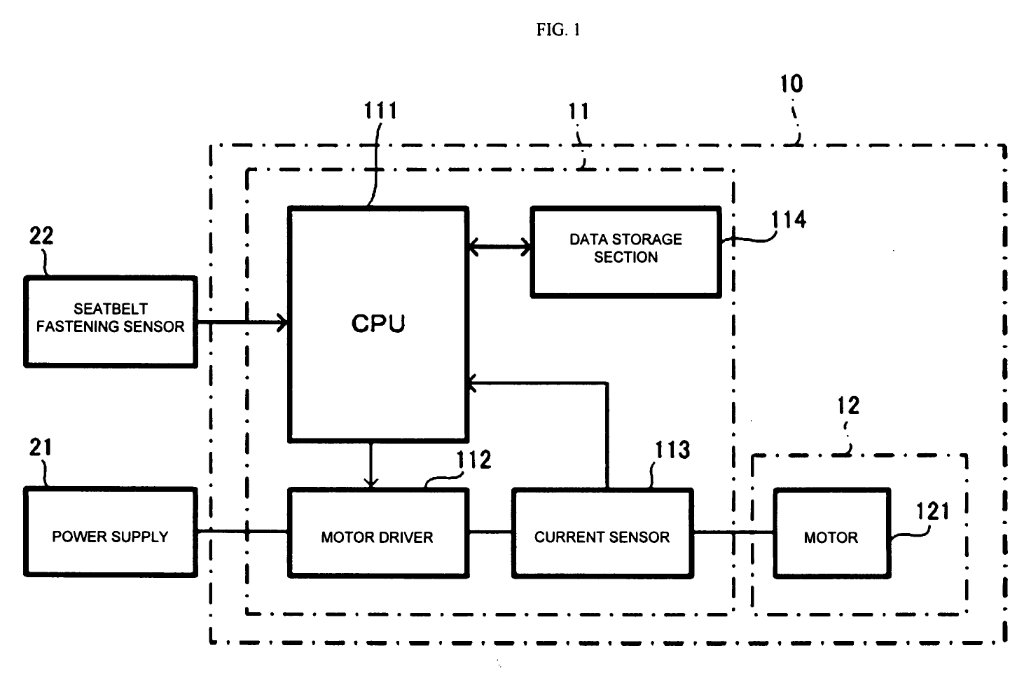

According to one embodiment, a seatbelt controller includes an ECU (Electronic Control Unit) 11 of a motor vehicle as shown in FIG. 1. The ECU 11 controls a motor 121 of a motor retractor 12. The ECU 11 and the motor retractor 12 are provided in a seatbelt retractor 10 for automatically retracting a seatbelt. As shown in FIG. 1, the ECU 11 includes a CPU (Central Processing Unit) 111, a motor driver 112, a current sensor 113, and a data storage section 114. Although not illustrated, the ECU 11 also includes ROM (Read Only Memory) and RAM (Random Access Memory) and the like.

The CPU 111 controls at least a portion of the operation of the seatbelt. Various types of sensors such as a seatbelt fastening sensor 22 (to be detailed later) and the like are connected to the CPU 111 (e.g., via a cord, wire, cable, etc.). To perform vehicle control, the CPU 111 executes a control method stored in the ROM or the like while causing, for example, the RAM to temporarily store various types of data. At this time, sensor information is used, if needed.

The data storage section 114 includes a writable memory such as an EEPROM (Electrically Erasable PROM) or a flash memory. The data storage section 114 (e.g., data storage portion) includes a parameter, a table, a flag, and the like for use in control stored or updated in advance or during control.

The motor driver 112 is electrically connected to the CPU 111 and a power supply 21. The motor driver 112 drives the motor 121 in accordance with a control signal from the CPU 111. The power supply 21 (e.g., an in-vehicle battery) supplies a power supply voltage to the motor driver 112. The current sensor 113 is disposed between, for example, the motor driver 112 and the motor 121. The current sensor 113 detects the value of a current flowing through the motor 121 and outputs the detected value to the CPU 111.

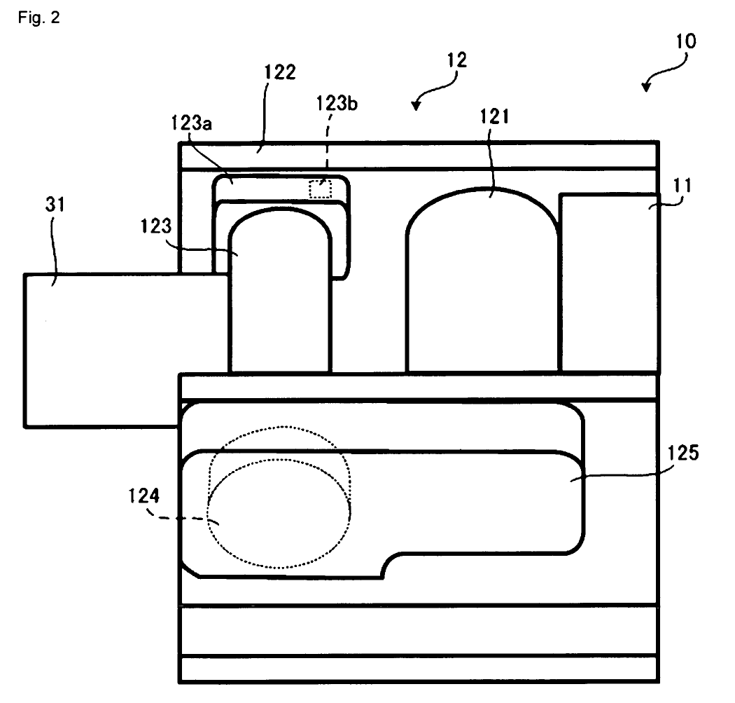

As shown in, for example, FIG. 2, the motor retractor 12 controlled by the ECU 11 includes the motor 121, a frame 122, a spool 123, an urging mechanism (e.g., a return spring 124), and a power transmission mechanism 125. The frame 122 is a substantially U-shaped framework of the motor retractor 12. The frame 122 supports various components such as the ECU 111 and the motor 121, that are secured to the frame 122 in the form as shown in FIG. 2.

The motor 121 is an electric motor with a rotating shaft coupled to the spool 123. The motor 121 is rotatable in both forward and backward directions. The motor 121 rotatably drives the spool 123. The spool 123 is a component around which a belt 31 is wound. The spool 123 is rotatably secured to the frame 122. A lock mechanism 123a is connected to the spool 123. The lock mechanism 123a has a torsion bar (not illustrated). A lock gear and a cam are coupled to one end of the torsion bar while the spool 123 is coupled to the other end of the torsion bar. The cam is coupled to the spool 123 directly or through reduction gears. An ELR (emergency locking retractor) switch 123b is provided proximate to the outer periphery of the cam such that it is in contact with the circumferential surface of the cam. The ELR switch 123b switches an inner contact (to the on or off position) in conjunction with the rotational position (projections of the cam) of the cam. The ELR switch 123b is positioned such that it is tripped by the cam connected to the spool 123 when the belt 31 is retracted an amount exceeding a predetermined level or value. The ELR switch 123b is used to lock rotational operation of the torsion bar in the event of, for example, an emergency. Also, the ELR switch 123b can detect the retracted amount of the belt 31.

The power transmission mechanism 125 includes a return spring 124, a predetermined number of gears, and, for example, a clutch mechanism consisting of a one-way clutch that engages in the retraction direction of the belt 31. The power transmission mechanism 125 transmits power generated by the motor 121 to the torsion bar and the spool 123 through a clutch or the like. The power transmission mechanism 125 is secured to, for example, the frame 122. The return spring 124 is directly connected to the spool 123. The motor 121 is coupled with the spool 123 via the clutch mechanism of the power transmission mechanism 125.

The motor retractor 12 can take up the belt 31 with the spool 123 through the rotation of the torsion bar. The return spring 124 is connected to the end of the torsion bar opposite the lock gears. According to an exemplary embodiment, the return spring 124 is a flat spiral spring. The return spring 124 is incorporated in the power transmission mechanism 125. The return spring 124 biases the spool 123 in the retraction direction of the belt 31. If the motor 121 is not activated and no withdrawing force is applied to the belt 31, the urging force of the return spring 124 acts on the belt 31, causing the belt 31 to be retracted. The return spring 124 is loosened or relaxed when the motor 121 rotates in the retraction direction of the belt 31. Greater retracted amount of the belt 31 results in weaker retracting force of the return spring 124. The retracting force is configured such that it does not give an occupant a feeling of tightness. In contrast, retracting force of the motor 121 is set greater than that of the return spring 124.

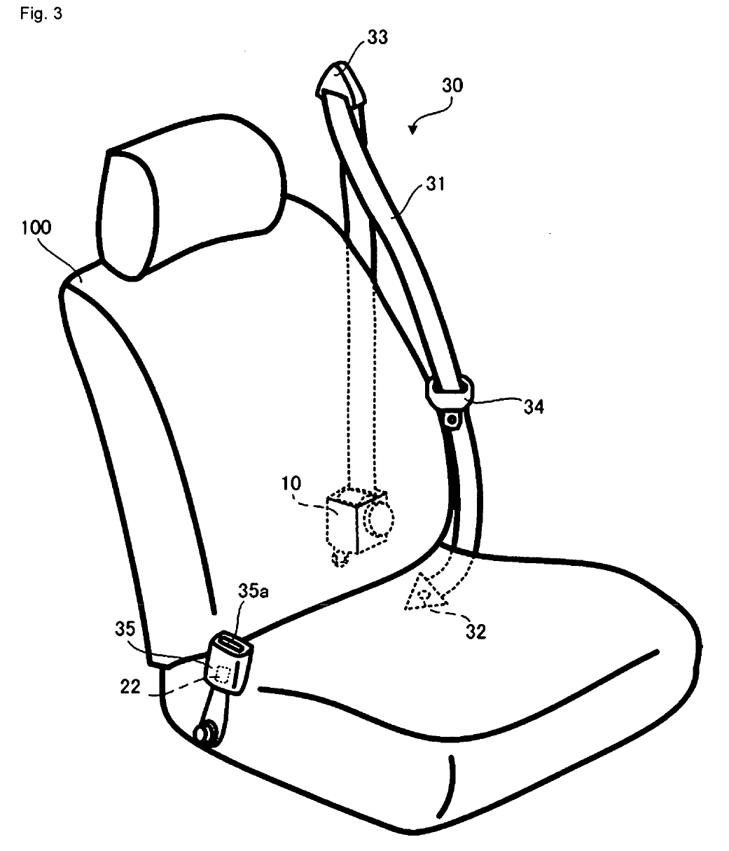

A seatbelt retractor 10 (FIG. 2) as described above is used in, for example, a seatbelt apparatus 30 as shown in FIG. 3. The seatbelt apparatus 30 includes the seatbelt retractor 10, a belt 30 (e.g., seatbelt, webbing, etc.), a belt anchor 32, a guide anchor 33, a tongue plate 34, and a belt fastening and releasing mechanism (e.g., a buckle 35). The seatbelt retractor 10 is installed in, for example, a vehicle seat 100 (driver's seat, a passenger seat, a rear seat, and the like). The seatbelt retractor 10 is secured to, for example, the inside of the side of a vehicle body.

The belt 31 restrains an occupant in a seat. The belt 31 extends between the seatbelt retractor 10 and the belt anchor 32. The belt anchor 32 secures one end of the belt 31 to the passenger compartment of a vehicle, such as to the floor of the vehicle body or the seat. The belt 31 is folded back the belt 31 in the vicinity of the shoulder of an occupant by the guide anchor 33. The guide anchor 33, through which the belt 31 is inserted, is secured to the side of a vehicle.

The belt 31 is fastened down to restrain the occupant with the tongue plate 34 and the buckle 35. The tongue plate 34 is slidably supported on the belt 31 that is folded back at the guide anchor 33. The buckle 35 has an insertion opening (slot) 35a formed in the vicinity of the waist of an occupant. When the tongue plate 34 is inserted into the insertion opening 35a, the tongue plate 34 is releasably engaged with the buckle 35.

The seatbelt fastening sensor 22 (FIG. 1) is provided in the buckle 35 for detecting that the tongue plate 34 is engaged. While the tongue plate 34 is engaged with the buckle 35, a signal detected by the seatbelt fastening sensor 22 is outputted to the seatbelt retractor 10 (specifically the CPU 111 as shown in FIG. 1) through a cord. For this reason, the ECU 111 can detect that the belt 31 is fastened or released (whether the buckle 35 is released or not) according to the presence of the signal from the seatbelt fastening sensor 22.

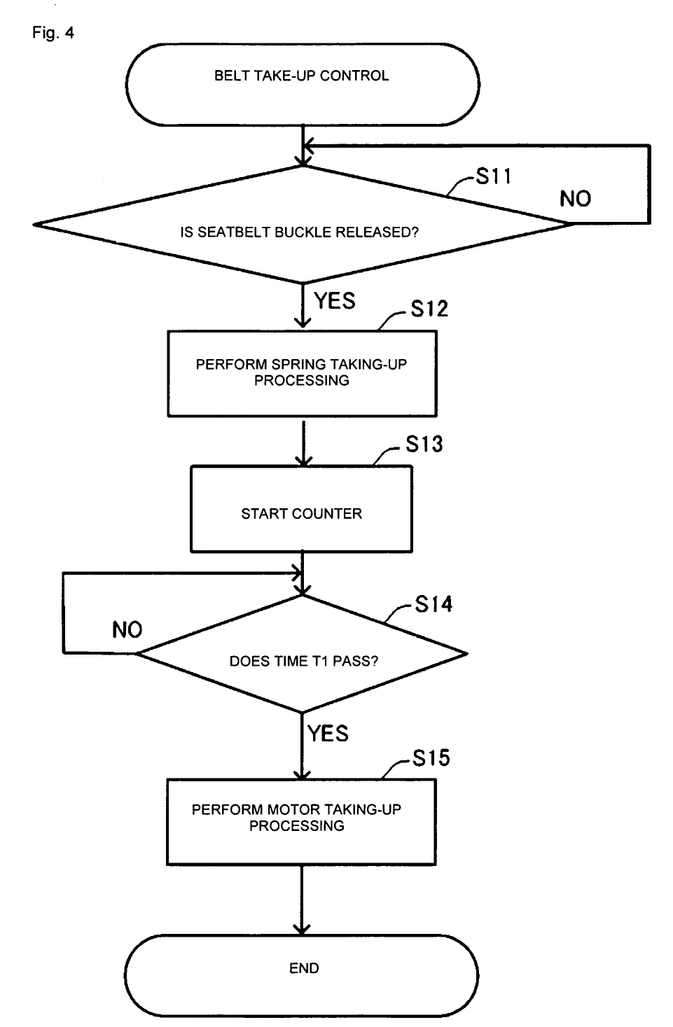

The seatbelt retractor 10 repeatedly performs, for example, a series of processing steps (belt retraction control) as shown in FIG. 4. In these processing steps, the CPU 111 in, for example, the ECU 11 reads out and executes a predetermined method from the ROM.

In step S11 of the processing steps in FIG. 4, the CPU 111 detects a signal from the seatbelt fastening sensor 22 to determine if the buckle 35 is released. If the buckle 35 is released, (e.g., released by a user), the CPU 111 determines in step S11 that the buckle 35 is released. Then, in step S12 the return spring 124 begins to retract (e.g., take-up) the belt 31. In the following step S13, the CPU 111 starts a counter, beginning counting from the reset state (counter=0). The counter may be mechanical or may be formed in a method.

In the following step S14, the CPU 111 checks a predetermined time T1 stored in the data storage section 114 and determines whether or not the counter value passes the predetermined time T1. The CPU 111 repeats processing of step S14 until the time T1 passes. Time T1 is set in advance (e.g., by experiment) to a time to cause retracting force of the return spring 124 to become weak to the point where no abnormal noise is emitted from the clutch or the like of the power transmission mechanism 125. More specifically, time T1 is set so that a period (period likely to cause abnormal noise) in which the retraction speed of the belt 31 by the return spring 124 is greater than the rotating speed of the motor 121 falls within a short period of an initial motor driving period.

In the following step S15, the CPU 111 causes the motor 121 to start retracting the belt 31. Specifically, the CPU 111 reads out a control parameter from, for example, a table stored in the data storage section 114, depending on the situation. Then the CPU 111 generates a PWM (Pulse Width Modulation) signal having a predetermined duty ratio in accordance with the control parameter. The CPU 111 outputs the PWM signal and a control signal for specifying the rotational direction of the motor 121 to the motor driver 112. The motor driver 112 receiving these signals creates a drive voltage by regulating the supply voltage with the PWM signal. Then the motor driver 112 applies the drive voltage to the motor 121. This causes the motor 121 to rotate at speeds based on the duty ratio of the drive voltage, causing the belt 31 to be retracted onto the spool 123. This retraction processing ends, for example, when the belt 31 is completely retracted.

The processing steps in FIG. 4 end when the processing steps in step S15 are terminated.

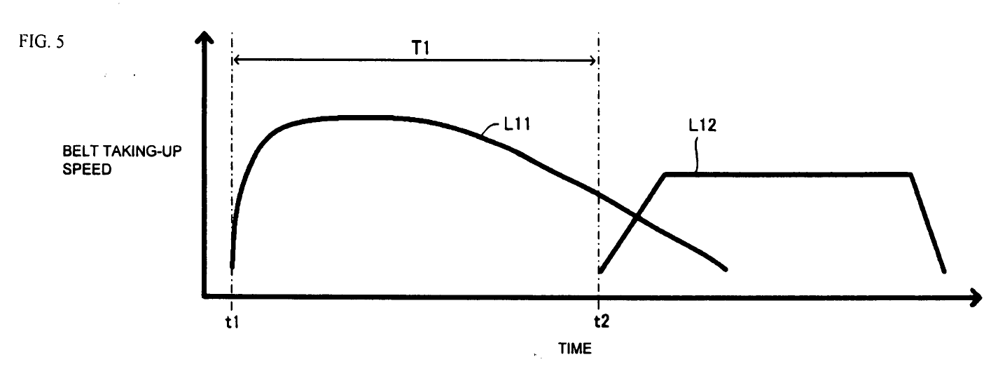

According to a series of the processing steps, if the buckle 35 is released by a user at, for example, timing t1 as shown in FIG. 5, the retraction of the belt 31 by the return spring 124 is started, as shown in Line L11 in FIG. 5. When time T1 passes after the beginning (timing t1) of the retraction, the motor 121 is driven at timing t2, causing the motor 121 to perform the retraction of the belt 31 as shown in Line L12 in FIG. 5.

The CPU 111 may read out all control parameters, for example, when a vehicle ignition key is turned on, and may store them in the register or the like of the RAM.

As just described above, the seatbelt retractor 10 according to an exemplary embodiment does not cause the motor 121 to be driven while the return spring 124 has retracting force strong enough to cause the abnormal noise when the motor 121 is driven. When the retracting force of the return spring 124 becomes sufficiently weak, driving the motor 121 is started. Accordingly, the seatbelt retractor 10 can suppress the abnormal noise emitted during the retraction of the belt.

A seatbelt apparatus, a seatbelt control apparatus, a seatbelt control method, and a method according to another exemplary embodiment will be described below. The apparatus configuration of this embodiment is similar to the embodiment described above, and, therefore, repeated descriptions of the same sections are omitted for the sake of simplicity.

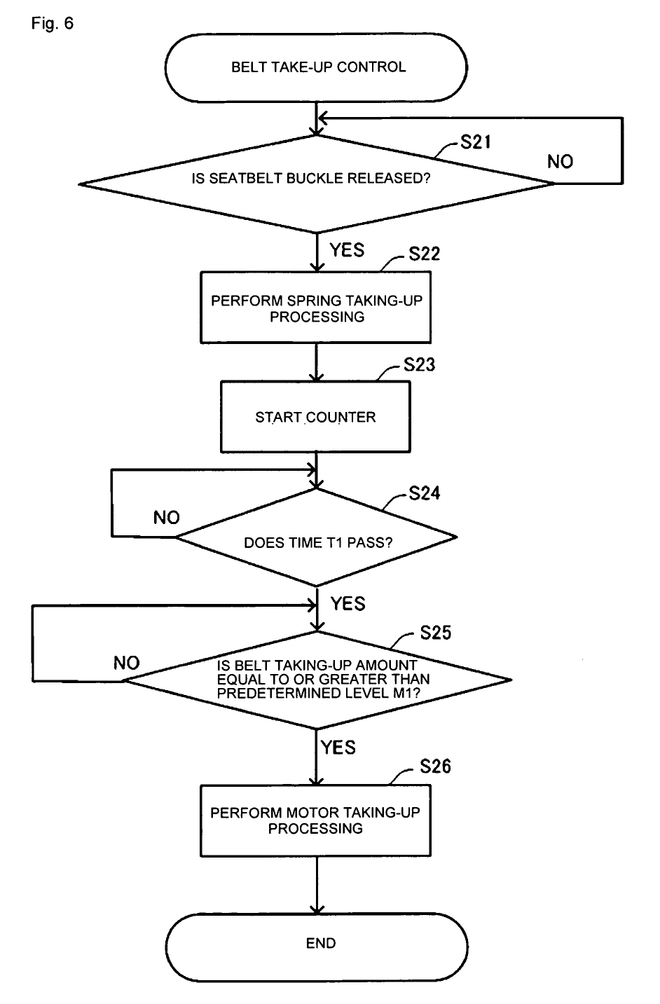

According to an exemplary embodiment, the seatbelt retractor 10 repeatedly performs a series of processing steps (belt retraction control) in FIG. 6, in place of the processing in FIG. 4, at predetermined time intervals according to, for example, a program. In the processing steps in FIG. 6, the CPU 111 performs the processing steps in steps S21 through S24 which are the same as those in steps S11 through S14 shown in FIG. 4.

In the following step S25, the CPU 111 uses, for example, an ELR switch 123b to determine whether or not the retracted amount of the belt 31 is equal to or greater than a predetermined level M1. Specifically, the ELR switch 123b is disposed so as to be switched by a cam connected to the spool 123 when the retracted amount the belt exceeds the predetermined level M1. Accordingly, the CPU 111 determines that the retracted amount of the belt exceeds the predetermined level M1 when the ELR switch 123b is switched after, for example, the buckle 35 is released. Time T1 and the predetermined level M1 are determined in advance (e.g., by experiment) to the time and the retracted amount, respectively, to cause the retracting force of the return spring 124 to become weak to the point where no abnormal noise is emitted from the clutch or the like of the power transmission mechanism 125. As just described above, by considering the retracted amount in addition to the time, determination can be made with a higher degree of accuracy as to whether or not the retracting force of the return spring 124 becomes weak to the point where no abnormal noise is generated.

The processing steps in step S25 are repeated until it is determined that the retracted amount of the belt 31 exceeds the predetermined level M1. In step S26, the CPU 111 starts to cause the motor 121 to perform retraction processing for the belt 31, like those in step S15. This retraction processing ends, for example, when the belt 31 is completely retracted.

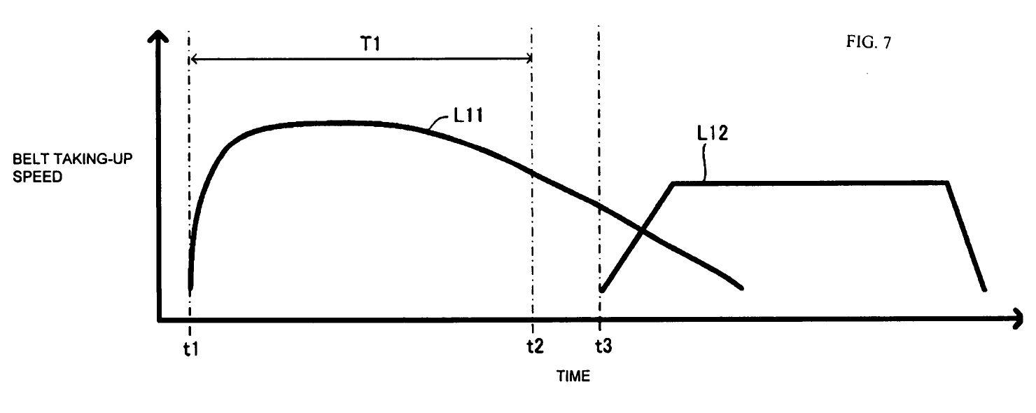

According to a series of the processing steps, if the buckle 35 is released by a user at, for example, timing t1 as shown in FIG. 7, the retraction of the belt 31 by the return spring 124 is started, as shown in Line L11 in FIG. 5. Following timing t2 when time T1 passes after the beginning (timing t1) of the retraction, at timing t3 when the retracted amount of the belt 31 exceeds the predetermined level M1, the motor 121 is driven, causing the motor 121 to perform the retraction of the belt 31 as shown in Line L12 in FIG. 7.

As just described above, by taking into consideration not only the time but also the retracted amount, the seatbelt retractor 10 according to an exemplary embodiment can determine with a higher degree of accuracy whether or not the retracting force of the return spring 124 becomes weak to the point where no abnormal noise is generated. Consequently, the seatbelt retractor 10 can more securely suppress the abnormal noise emitted during the belt retraction.

The order of the processing steps related to the embodiments above is not limited to the order shown in the flowcharts. Changes may be made to the order for efficiency reasons, for example.

The programs according to the embodiments above may be distributed in the form of computer readable recording media, such as a flexible disk, a CD-ROM (Compact Disk Read-Only Memory), a DVD (Digital Versatile Disk), and an MO (Magneto-Optical disk). In this case, the processing steps described above may be performed by installing the programs in a predetermined computer. Also, the programs according to the embodiments above may be stored in the storage unit (hard disk or the like) of a server provided on a communication network (for example the Internet or an intranet), and may be down-loaded to a local computer through, for example, superimposing on a carrier wave or may be read out from the server as needed to a local computer in which the programs are activated and executed. If part of the functions are performed by an OS (Operating System), only part of the functions other than performed by the OS may be distributed or transferred.

Means for implementing the functions of the ECU 111 is not limited to software, and a part or the whole of them may be implemented by dedicated hardware.

Depending on applications, the apparatus configuration as shown in FIGS. 1 to 3 may be accordingly changed.

Any method of detecting, for example, the retracted amount, namely, any retracted amount detecting mechanism may be used. For example, in addition to the ELR switch 123b, another switch may be provided in the circumferential vicinity of the cam, thereby determining with a higher degree of accuracy whether or not the retracted amount of the belt 31 exceeds the predetermined level. Alternatively, the CPU 111 may calculate the retracted amount from the driving amount of the motor 121 or the rotating amount of the spool 123.

Although the embodiments above are described using an example where a seatbelt apparatus 30 is installed on the seat of a motor vehicle, the embodiments are not limited to a motor vehicle, and may be applied to the seats of other vehicles such as aircraft.

The priority application, Japanese Patent Application No. 2008-287208, filed Nov. 7, 2008, including the specification, drawings, claims and abstract, is incorporated herein by reference in its entirety.

The construction and arrangements of the seatbelt apparatus, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

What is claimed is:

1. A seatbelt apparatus comprising:
a seatbelt;
a spool for retracting the seatbelt;
a motor for rotatably driving the spool;
urging mechanism for urging the seatbelt toward a retracting direction;
belt attaching/detaching mechanism adapted to attach/detach the seatbelt for fastening or releasing the seatbelt,
belt releasing detecting mechanism for detecting that the seatbelt is released from the belt attaching/detaching mechanism; and
motor controller configured to cause the motor to start to take up the seatbelt when a predetermined amount of time passes since the belt releasing detecting mechanism detects that the seatbelt is released.

2. The seatbelt apparatus according to claim 1, wherein the motor controller is configured to cause the motor to start to take up the seatbelt on the condition that the retracted amount of the seatbelt is equal to or greater than a predetermined level, in addition to the condition described above.

3. A seatbelt control apparatus that controls an apparatus including a seatbelt, a spool for retracting the seatbelt, a motor for rotatably driving the spool, urging mechanism for urging the seatbelt toward a retracting direction; and belt attaching/detaching mechanism adapted to attach/detach the seatbelt for fastening or releasing the seatbelt, the seatbelt control apparatus comprising:
a belt releasing detecting mechanism for detecting that the seatbelt is released from the belt attaching/detaching mechanism; and
a motor controller configured to cause the motor to start to take up the seatbelt on the condition that a predetermined amount of time passes since the belt releasing detecting mechanism detects that the seatbelt is released.

4. A seatbelt control method for controlling an apparatus which includes a seatbelt, a spool for retracting the seatbelt, a motor for rotatably driving the spool, urging mechanism for urging the seatbelt toward a retracting direction, and belt attaching/detaching mechanism adapted to attach/detach the seatbelt for fastening or releasing the seatbelt, the seatbelt control method comprising:
determining an amount of time during which an urging force of the urging mechanism becomes weaker than a predetermined level;
detecting that the seatbelt is released from the belt attaching/detaching mechanism; and
causing the motor to start to take up the seatbelt on the condition that the amount of time determined in the first step passes since the second step detects that the seatbelt is released.

5. A method of controlling an apparatus which includes a seatbelt, a spool for retracting the seatbelt, a motor for rotatably driving the spool, urging mechanism for urging the seatbelt toward a retracting direction, and belt attaching/detaching mechanism adapted to attach/detach the seatbelt for fastening or releasing the seatbelt, the method comprising the steps of:
a belt releasing detecting step of detecting that the seatbelt is released from the belt attaching/detaching mechanism; and
a motor control step of causing the motor to start to take up the seatbelt on the condition that a predetermined amount of time passes since the belt releasing detecting step detects that the seatbelt is released.
